(19) United States
(12) Patent Application Publication
(10) Pub. No.: US 2008/0049139 A1
(43) Pub. Date: Feb. 28, 2008

(54) METHOD AND DEVICE FOR SYNCHRONOUS CONTROL OF IMAGE SIGNAL AND AUDIO SIGNAL IN IMAGE APPARATUS

(75) Inventor: Haruyasu NISHIYAMA, Kato (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/856,368

(22) Filed: Sep. 17, 2007

Related U.S. Application Data
(63) Continuation of application No. PCT/JP2005/004987, filed on Mar. 18, 2005.

(51) Int. Cl. H04N 5/44

(52) U.S. Cl. 348/515; 348/E05.108

(57) ABSTRACT

When a certain signal processing is performed on each of an image signal and an audio signal, an object is to correct a delay of the signal so as to synchronize the signals. An image signal processing portion (12, 16) that performs signal processing on an input image signal and an input audio signal, an input signal detecting portion (NS) that stores a signal state of the input image signal or the input audio signal, an output signal detecting portion (SS) that stores a signal state of the image signal or the audio signal after the signal processing performed by the image signal processing portion (12, 16), an image delay detecting portion (25) and an sound delay detecting portion (26) that compare the image signal and the audio signal stored in the input signal detecting portion NS with those stored in the output signal detecting portion SS so as to determine delay time (n) and delay time (k), a delay correction amount detecting portion (27) that determines delay correction amount (HRV, HRA) with respect to the image signal or the audio signal based on a difference between the delay time (n) and the delay time (k), a delay correcting portion (13, 17) that corrects a delay of the image signal or the audio signal to be delivered based on the determined delay correction amount, an image output portion (14) that delivers an image, and a sound output portion (18) that delivers sound are provided.

### TECHNICAL FIELD

The present invention relates to a method and a device for synchronous control of an image signal and an audio signal in an image apparatus such as a television set, a DVD reproduction apparatus, an AV apparatus, a display device for them, or the like.

### BACKGROUND ART

Recently, a lot of television sets and AV apparatuses have a function of performing digital processing on an image signal and an audio signal before an image is displayed and a sound is produced. In the digital processing, conversion of the image signal from an interlace signal into a progressive signal and other various processes for improving image quality are performed using a frame memory or the like in many cases. In this case, there is time delay corresponding to a few frames until the image is produced. Therefore, a time difference between the image and the sound occurs, so that a user (viewer) may have uncomfortable feeling.

As a countermeasure against this, there is proposed a method of storing delay amounts of the sound with respect to the image for types of data processing as a database, and reading out the delay amount for a type of data processing from the database for performing correction (see U.S. Pat. No. 6,862,044).

In addition, it is pointed out that when a set top box is used corresponding to digital television broadcasting, there is time delay of the audio signal corresponding to the time period necessary for decoding it in an external device, and a countermeasure against it is proposed (see Japanese unexamined patent publication No. 2003-46901). According to Japanese unexamined patent publication No. 2003-46901, a delay amount of the audio signal decoded by an external device from a stream output delivered from the set top box with respect to the audio signal delivered from the set top box is measured. The image signal is delayed by the measured delay amount so that lip-sync is adjusted.

However, the above-mentioned method of U.S. Pat. No. 6,862,044 cannot support the case where data processing of a type except the types stored in the database in advance. In addition, the device of Japanese unexamined patent publication No. 2003-46901 is effective in the case where an audio signal and a stream output delivered from the set top box are decoded in an external device, but it cannot be applied to an image apparatus that does not receive and decode such a stream output.

Therefore, the methods of U.S. Pat. No. 6,862,044 and Japanese unexamined patent publication No. 2003-46901 have a problem about how to correct a delay of the signal for synchronization when a certain signal processing is performed on both the image signal and the audio signal.

An object of the present invention is to provide a method and a device for synchronous control in which a delay of the signal is corrected for synchronization when a certain signal processing is performed on both the image signal and the audio signal.

### DISCLOSURE OF THE INVENTION

A method according to one aspect of the present invention is a synchronous control method between an image signal and an audio signal in an image apparatus having an image signal processing portion that performs signal processing on an input image signal, an image output portion that delivers the image after the signal processing, an audio signal processing portion that performs signal processing on an input audio signal and a sound output portion that delivers the sound after the signal processing. The method includes the steps of storing signal states of the input image signal and the input audio signal in an input image storing portion and an input sound storing portion, respectively, storing signal states of the image signal after the signal processing performed by the image signal processing portion and the audio signal after the signal processing performed by the audio signal processing portion in an output image storing portion and an output sound storing portion, respectively, comparing the image signal stored in the input image storing portion with the image signal stored in the output image storing portion so as to determine delay time of the image signal, comparing the audio signal stored in the input sound storing portion with the audio signal stored in the output sound storing portion so as to determine delay time of the audio signal, determining a delay correction amount with respect to the image signal or the audio signal based on a difference between the determined delay time of the image signal and the determined delay time of the audio signal, and correcting a delay of the image signal or the audio signal to be delivered, in accordance with the determined delay correction amount.

A device according to another aspect of the present invention includes an input image storing portion that stores a signal state of the input image signal, an input sound storing portion that stores a signal state of the input audio signal, an output image storing portion that stores a signal state of the image signal after the signal processing performed by the image signal processing portion, an output sound storing portion that stores a signal state of the audio signal after the signal processing performed by the audio signal processing portion, an image delay time detecting portion that compares the image signal stored in the input image storing portion with the image signal stored in the output image storing portion so as to determine delay time of the image signal, a sound delay time detecting portion that compares the audio signal stored in the input sound storing portion with the audio signal stored in the output sound storing portion so as to determine delay time of the audio signal, a delay correction amount detecting portion that determines a delay correction amount with respect to the image signal or the audio signal based on a difference between the determined delay time of the image signal and the determined delay time of the audio signal, and a delay correcting portion that corrects a delay of the image signal or the audio signal to be delivered, in accordance with the determined delay correction amount.

Preferably, the image delay time detecting portion may determine a variation of the image signal stored in the input image storing portion and a variation of the image signal stored in the output image storing portion, so that the delay time of the image signal is determined from a position where correlation between the variations is highest, and the sound delay time detecting portion may determine a variation of the audio signal stored in the input sound storing portion and a variation of the audio signal stored in the output sound storing portion, so that the delay time of the audio signal is determined from a position where correlation between the variations is highest.

In addition, the input image storing portion and the output image storing portion may sample and store a luminance signal at a constant period as the signal state of the image signal. Alternatively, they may store a frequency component of each frame or a frequency component every predetermined time period. Alternatively, they may sample and store a variation of a luminance signal at a constant period.

In addition, the input sound storing portion and the output sound storing portion may sample and store a variation of the audio signal at a constant period as the signal state of the audio signal.

According to the present invention, when a certain signal processing is performed on each of an image signal and an audio signal, a delay of the signal due to the signal processing can be corrected so that synchronization between the signals can be realized.

### BRIEF DESCRIPTION OF THE DRAWINGS

FIG. 1 is a block diagram showing a structure of a display device according to an embodiment of the present invention.

FIG. 2 is a block diagram showing a function of a portion performing a process and control with respect to an image signal.

FIG. 3 is a block diagram showing a function of a portion performing a process and control with respect to an audio signal.

FIG. 4 is a diagram showing an example of a relationship between a signal state on the input side and a signal state on the output side.

FIG. 5 is a diagram showing a correlation relationship with respect to the signal state shown in FIG. 4.

FIG. 6 is a flowchart showing a synchronous control method.

### BEST MODE FOR CARRYING OUT THE INVENTION

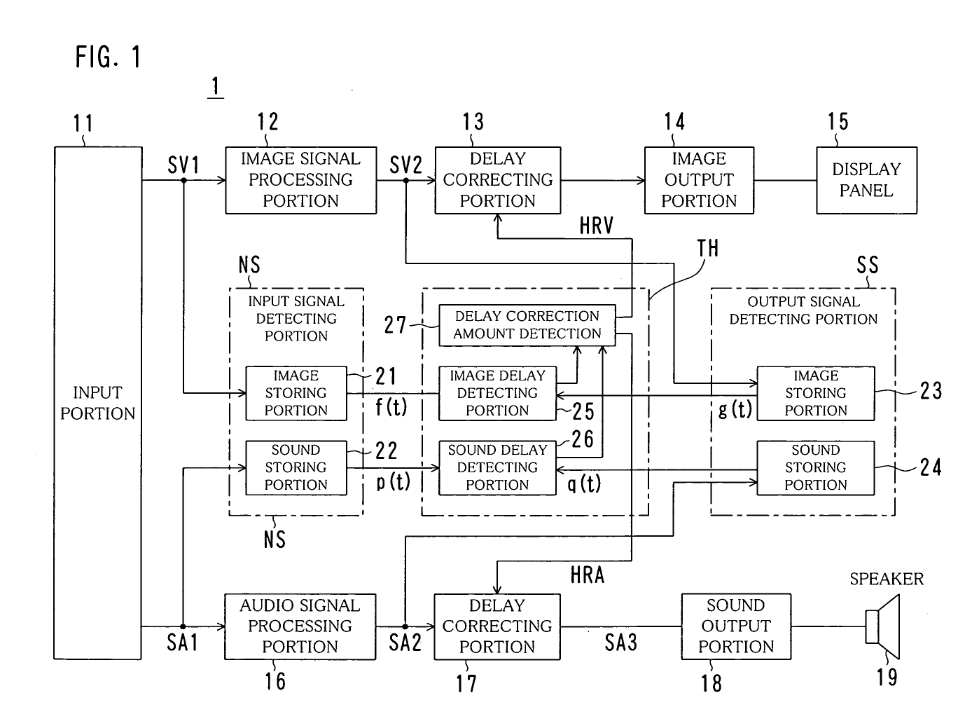

FIG. 1 is a block diagram showing a structure of a display device 1 according to an embodiment of the present invention.

As shown in FIG. 1, the display device 1 is made up of an input portion 11, an image signal processing portion 12, a delay correcting portion 13, an image output portion 14, a display panel 15, an audio signal processing portion 16, a delay correcting portion 17, a sound output portion 18, a speaker 19, an image storing portion 21, a sound storing portion 22, an image storing portion 23, a sound storing portion 24, an image delay detecting portion 25, a sound delay detecting portion 26, and a delay correction amount detecting portion 27 and the like.

The input portion 11 receives an image signal SV1 and an audio signal SA1 from an external device. Each of the image signal and the audio signal to be received is a function of time. As an external device, various types of television tuners, a DVD apparatus, a video tape reproduction apparatus, a personal computer or the like is connected, for example.

The image signal processing portion 12 performs a signal processing on the input image signal SV1 and delivers an image signal SV2. Here, as the signal processing, there are an image quality correction process, a color correction process, a progressive conversion process and other processes, for example.

The delay correcting portion 13 corrects a delay of the image signal SV2 in accordance with a delay correction amount HRV delivered from the delay correction amount detecting portion 27, and it delivers an image signal SV3.

The image output portion 14 delivers an image after the signal processing. The image output portion 14 is a driving circuit for the display panel 15 such as a liquid crystal panel or a PDP panel, for example. In addition, the image output portion 14 can be used for delivering the image signal externally.

The audio signal processing portion 16 performs a signal processing on the input audio signal SA1 and outputs an audio signal SA2. Here, as the signal processing, there are a sound quality correction process, a surround process and other processes, for example.

The delay correcting portion 17 corrects a delay of the audio signal SA2 in accordance with a delay correction amount HRA delivered from the delay correction amount detecting portion 27, and it delivers an audio signal SA3.

The sound output portion 18 delivers the sound after the signal processing. The sound output portion 18 is a power amplifying circuit for the speaker 19, for example. In addition, it is possible to use the sound output portion 18 for delivering the audio signal externally.

The image storing portion 21 stores a signal state f(t) of the input image signal SV1.

The sound storing portion 22 stores a signal state p(t) of the input audio signal SA1.

The image storing portion 23 stores a signal state g(t) of the image signal SV2 after the signal processing performed by the image signal processing portion 12.

The sound storing portion 24 stores a signal state q(t) of the audio signal SA2 after the signal processing performed by the audio signal processing portion 16.

Note that the image storing portion 21 and the image storing portion 23 may sample and store a luminance signal at a constant period, as the signal states f(t) and g(t) of the image signal. In this case, a luminance signal of a particular pixel or an average luminance signal of a particular area or the entire area, or the like may be used as the above-mentioned luminance signal. In addition, a frequency component (frequency characteristic) of each frame may be stored as the signal states f(t) and g(t) of the image signal. In this case, a histogram of the frequency component is determined for each frame by using a spectrum analyzer, for example, so as to store it.

In addition, a variation of the luminance signal may be sampled and stored at a constant period as the signal states f(t) and g(t) of the image signal.

In addition, the sound storing portion 22 and the sound storing portion 24 may sample and store amplitude of the audio signal at a constant period as the signal states p(t) and q(t) of the audio signal. In addition, a frequency component (frequency characteristic) may be stored every predetermined time ts as the signal states p(t) and q(t) of the audio signal.

In addition, a variation of the audio signal may be sampled and stored at a constant period as the signal states p(t) and q(t) of the audio signal.

The image delay detecting portion 25 compares the image signal (its signal state) f(t) stored in the image storing portion 21 on the input side with the image signal (its signal state) g(t) stored in the image storing portion 23 on the output side, so as to determine the delay time n of the image signal.

The image delay detecting portion 25 determines a variation Df of the image signal f(t) stored in the image storing portion 21 and a variation Dg of the image signal g(t) stored in the image storing portion 23, for example, and it determines the delay time n of the image signal from a position having the highest correlation between the variations Df and Dg.

The sound delay detecting portion 26 compares the audio signal (its signal state) p(t) stored in the sound storing portion 22 on the input side with the audio signal (its signal state) q(t) stored in the sound storing portion 24 on the output side, so as to determine the delay time k of the audio signal.

The sound delay detecting portion 26 determines a variation Dp of the audio signal p(t) stored in the sound storing portion 22 and a variation Dq of the audio signal q(t) stored in the sound storing portion 24, for example, and it determines the delay time k of the audio signal from a position having the highest correlation between the variations Dp and Dq.

The delay correction amount detecting portion 27 determines the delay correction amounts HRV and HRA with respect to the image signal SV2 and the audio signal SA2 based on a difference between delay time n of the image signal determined by the image delay detecting portion 25 and the delay time k of the audio signal determined by the sound delay detecting portion 26.

Note that the storing process in the image storing portions 21 and 23 and the sound storing portions 22 and 24, the signal processing by the image signal processing portion 12 and the audio signal processing portion 16, and the like are performed in real time.

The image storing portion 21 and the sound storing portion 22 on the input side constitute an input signal detecting portion NS, while the image storing portion 23 and the sound storing portion 24 on the output side constitute an output signal detecting portion SS. In addition, the image delay detecting portion 25, the sound delay detecting portion 26 and the delay correction amount detecting portion 27 constitute a delay time calculating portion TH.

These functions of individual portions of the display device 1 can be realized by using appropriate hardware elements or by an appropriate program executed by a CPU in a software manner or by a combination of them. This display device 1 corresponds to an image apparatus, an AV apparatus and a synchronous control device in the present invention.

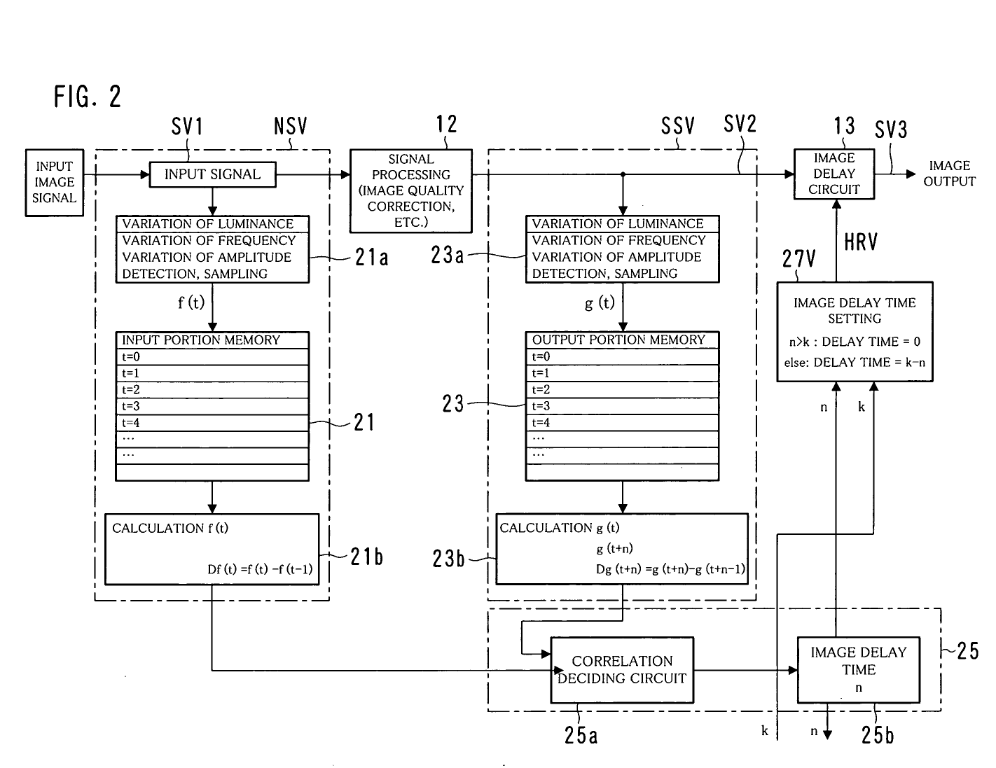

Next, a structure of the display device 1 will be described more in detail with reference to FIGS. 2 to 5.

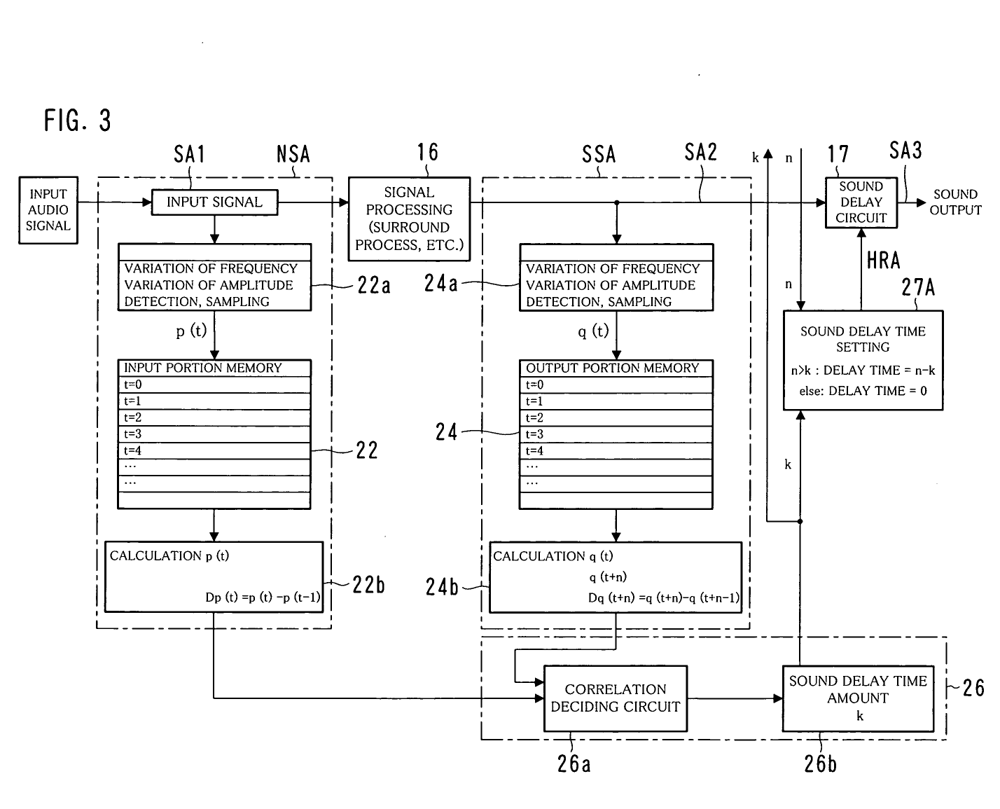

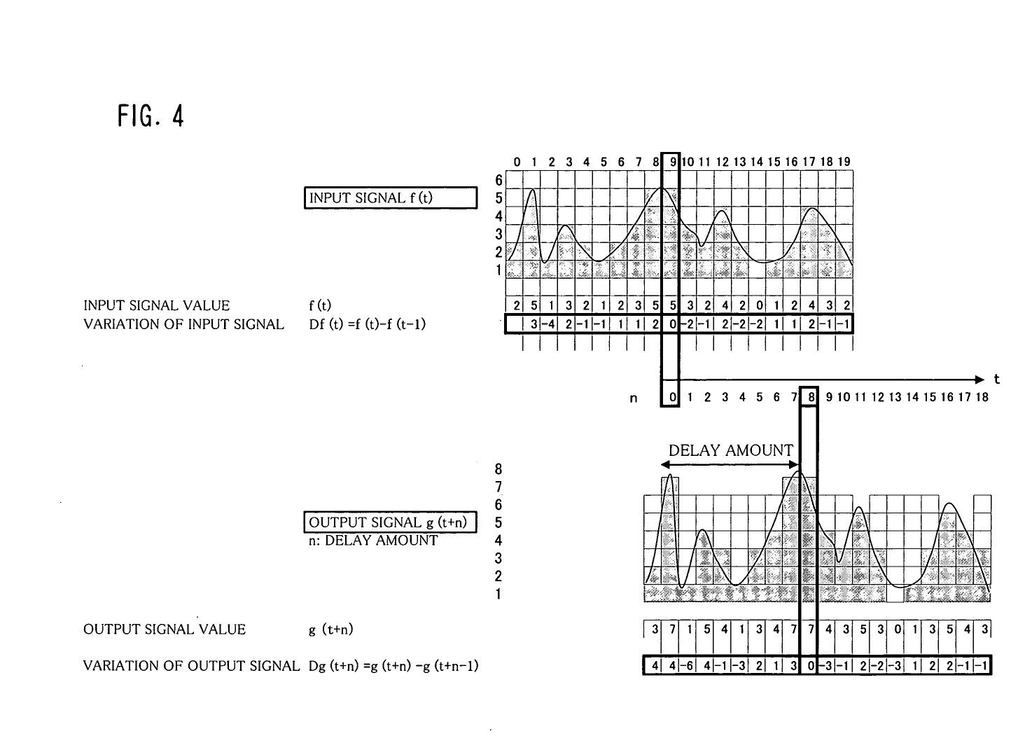

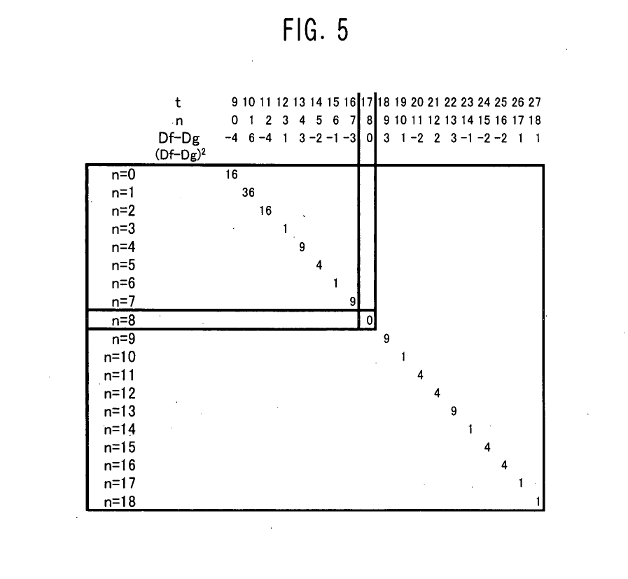

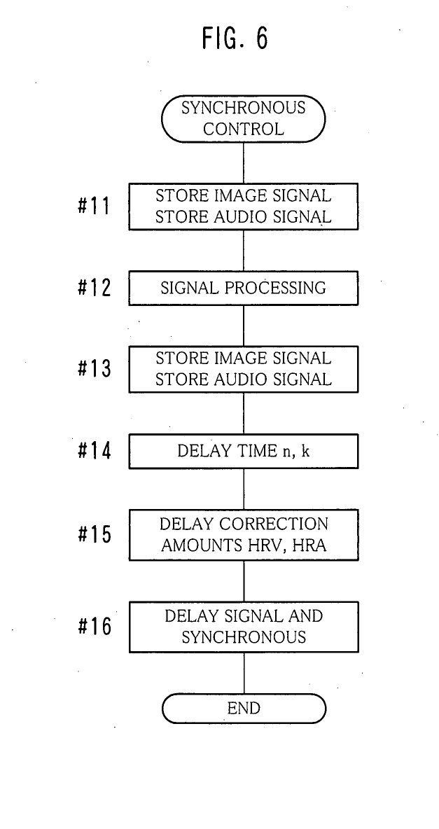

FIG. 2 is a block diagram showing a function of a portion performing a process and control with respect to an image signal, FIG. 3 is a block diagram showing a function of a portion performing a process and control with respect to an audio signal, FIG. 4 is a diagram showing an example of a relationship between a signal state on the input side and a signal state on the output side, FIG. 5 is a diagram showing a correlation relationship with respect to the signal state shown in FIG. 4, and FIG. 6 is a flowchart showing a synchronous control method.

Note that the block diagrams shown in FIGS. 2 and 3 include a part that is common with the block diagram shown in FIG. 1 and a modified part thereof. In other words, the block diagrams shown in FIGS. 2 and 3 can be considered as partial variations of the block diagram shown in FIG. 1.

As shown in FIG. 2, an input signal detecting portion NSV detects a variation state of the luminance signal, a variation state of the frequency, a variation state of the amplitude and the like with respect to the input image signal SV1, and it samples them at a constant period ts, i.e., every time period t0, t1, t2, t3 and so on. The image signal f(t) (t=0, 1, 2 and so on) obtained by the sampling is stored in the image storing portion (input portion memory) 21. A calculating portion 21b determines the variation Df from the image signal f(t) read out from the image storing portion 21. Therefore, the variation Df is shown in the following expression (1).
Df=f(t)−f(t−1) (1)

As to the image signal SV2 after the signal processing performed by the image signal processing portion 12, an output signal detecting portion SSV detects and samples a variation state of the luminance signal, a variation state of the frequency, a variation state of the amplitude and the like at a constant period ts in the same manner as the case of the input signal detecting portion NSV. The image signal g(t) (t=0, 1, 2 and so on) obtained by the sampling is stored in the image storing portion (output portion memory) 23. However, the image signal SV2 is delayed from the image signal SV1 by n times the sampling period for the process performed by the image signal processing portion 12, so the image signal g(t) (t=0, 1, 2 and so on) stored in the image storing portion 23 actually uses “t+n” instead of “t” and is expressed as g(t+n). The calculating portion 23b determines a variation Dg from the image signal g(t+n) read out from the image storing portion 23. In other words, the variation Dg is shown in the following expression (2).
Dg=g(t+n)−g(t+n−1) (2)

Note that the variation Dg shown in the expression (2) is Dg(t+n).

Then, the image delay detecting portion 25 determines the delay time n of the image signal from a position having the highest correlation between the variations Df and Dg.

In FIG. 4, a graph of a certain input signal (image signal) f(t) is shown. In the lower part of the graph, amplitudes f(t) of the input signal and their variations Df at t=0, 1, 2 and so on are shown as values. For example, the input signal f(t) has values of 5, 1, 3 and 2 at t=1, 2, 3 and 4. The variation Df has values of 3, −4, 2 and −1 at t=1, 2, 3 and 4.

In addition, in the lower part of it, a graph of the output signal (image signal) g(t) is shown in a delayed manner by n times the sampling period. Below the graph, values of the output signal (g(t+n)) and the variations Dg thereof at t=0+n, 1+n, 2+n and so on are shown as values. For example, the output signal g(t) has values of 3, 7, 1, 5 at t=10, 11, 12 and 13. The variation Dg has values of 4, −6, 4, −1 at t=10, 11, 12 and 13. Note that when t=9, i.e., the input signal f(t)=0, n is shown to be zero (n=0) in FIG. 4.

In FIG. 5, there are shown values of differences (Df−Dg) between zero as a reference that is the variation Df of the input signal f(t) when t=9, i.e., n=0, and the variations Dg of the output signals g(t) when n=0, 1, 2, 3 and so on. Below them, there are shown values of square of the difference (Df−Dg), i.e., (Df−Dg)2.

In the table shown in FIG. 5, the position where the square of the difference (Df−Dg)2 becomes minimum is the position of n=8, and the value thereof is 0. In other words, at the position of t=17 and n=8, the variation Df (=0) of the input signal f(t) is equal to the variation Dg (=0) of the output signal g(t), and the square of the difference (Df−Dg)2 becomes minimum 0. Therefore, the delay time n of the image signal SV2 is determined to be “8” as a result of the process performed by the image signal processing portion 12.

In this way, the image delay detecting portion 25 determines the position having the highest correlation between the variation Df of the input signal and the variation Dg of the output signal with a correlation deciding circuit 25a, and the delay time n is determined based on the position.

As shown in FIG. 3, an input signal detecting portion NSA and an output signal detecting portion SSA determine the variations Dp and Dq by using the expressions (3) and (4) for the audio signal SA, similarly to the image signal SV described above.
Dp=p(t)−p(t−1) (3)
Dq=q(t+n)−q(t+n−1) (4)

Then, the sound delay detecting portion 26 determines the delay time k of the audio signal from the position having the highest correlation between the variations Dp and Dq.

Based on the determined delay times n and k, delay correction amount detecting portions 27V and 27A determine the delay correction amounts HRV and HRA, respectively.

More specifically, the delay correction amount detecting portion 27V shown in FIG. 2 compares the delay time n with the delay time k. If n>k, the delay correction amount HRV is set to 0. If the delay correction amount HRV is zero, it means that there is no delay. Otherwise, i.e., if n≦k, the delay correction amount HRV is set to the value (k−n). In other words, an absolute value of the difference between the delay time n and the delay time k is set as the delay correction amount HRV.

In addition, the delay correction amount detecting portion 27A shown in FIG. 3 also compares the delay time n with the delay time k. If n>k, the delay correction amount HRA is set to the value (n−k). In other words, an absolute value of the difference between the delay time n and the delay time k is set as the delay correction amount HRA. Otherwise, i.e., if n≦k, the delay correction amount HRA is set to zero.

The delay correcting portion 13 corrects a delay of the image signal SV2 in accordance with the value obtained as the delay correction amount HRV, so as to deliver the image signal SV3. The delay correcting portion 17 corrects a delay of the image signal SA2 in accordance with the value obtained as the delay correction amount HRA, so as to deliver the image signal SA3.

In this way, one of the image signal SV2 and the audio signal SA2, which is more delayed, is regarded as a reference, and the other is further delayed by the difference (|n−k|) between the delay time n and the delay time k. Thus, it is able to obtain the image signal SV3 and the audio signal SA3 that are synchronized with each other.

Furthermore, the storing process of the signals performed by the input signal detecting portion NS and the output signal detecting portion SS, the calculation of the delay time n and the delay time k performed by the image delay detecting portion 25 and the sound delay detecting portion 26, and the calculation of the delay correction amounts HRV and HRA performed by the delay correction amount detecting portion 27 should be performed at an appropriate timing while the display device 1 is operating. For example, the processes are performed when the display device 1 is powered on, or once in the initial setting process just after the power on. Alternatively, the processes may be performed a plurality of times, e.g., three times, and if the three sets of delay correction amounts HRV and HRA obtained as the results when the process is performed three times are the same, the value is set. If they are not the same, the process is further performed three times. In addition, the calculation of the delay correction amounts HRV and HRA is performed as an appropriate time interval while the display device 1 is operating.

In addition, if the process content of the image signal processing portion 12 or the audio signal processing portion 16 is changed, the delay correction amounts HRV and HRA are recalculated. For example, the delay correction amounts HRV and HRA are recalculated every time in the case where the process content of the image signal processing portion 12 or the audio signal processing portion 16 is changed in accordance with a change of the transmission line, or in the case where the delay time n and the delay time k are changed in accordance with a change of the transmission line, or in other cases. In addition, the delay correction amounts HRV and HRA are recalculated at a predetermined time interval, e.g., every ten minutes, if a change in the process content of the image signal processing portion 12 or the audio signal processing portion 16 is expected.

The calculated delay correction amounts HRV and HRA should be kept in the delay correction amount detecting portion 27 or the delay correcting portion 13 or 17.

Next, a general flow of the synchronous control will be described with reference to a flowchart.

As shown in FIG. 6, the signal states of the input image signal SV1 and the input audio signal SA1 are stored (#11). In parallel with the process, the signal processing is performed with respect to the image signal SV1 and the audio signal SA1 (#12). The signal states of the image signal SV2 and the audio signal SA2 after the signal processing are stored (#13). The delay time n and the delay time k of the output signals from the input signals are determined with respect to the image signal and the audio signal (#14). The delay correction amounts HRV and HRA are determined from the delay time n and the delay time k (#15). Based on the delay correction amounts HRV and HRA, the image signal or the audio signal is delayed (#16).

According to the display device 1 of the embodiment described above, when certain signal processing is performed with respect to the image signal SV or the audio signal SA, a delay of the signal due to the signal processing is corrected so that synchronization between the image signal and the audio signal can be realized. As a result, there is no time difference between an image displayed on the display panel 15 and a sound delivered from the speaker 19 so that a viewer can enjoy natural image and sound without incompatibility.

When the delay time n and the delay time k are determined, a variation between the input signal and the output signal is determined so that the delay time n and the delay time k are determined from a position having highest correlation of the variation between them. Therefore, each of the delay time n and the delay time k can be determined correctly. In other words, although a level (amplitude) of the signal alters, a variation of the signal is not altered so much. Therefore, checking correlation of the variation, the delay time n and the delay time k can be determined correctly.

Although a square of the difference of the variation (Df−Dg)2 is determined for checking the correlation relationship in the example shown in FIGS. 4 and 5, it is not always necessary to determine the square. In addition, although the case where each of the signals f(t), g(t), p(t) and q(t) is one type is exemplified, the signals may be a plurality of types. In this case, a position where the difference of the variation becomes a minimum value according to the least square method should be determined with respect to each of the signals. For example, if a luminance signal is used as the image signal f(t), a plurality of luminance signals with respect to a plurality of different particular points (pixels) within the image are used so that the position where the difference of the variation becomes minimum is determined by the least square method with respect to differences of variations of the plurality of luminance signals.

In addition, since one of the delay correcting portions 13 and 17 sets the delay correction amount HR to zero, it can minimize the delay time so that distortion or the like of the signal can be minimized. However, each of the delay correcting portions 13 and 17 can perform the delay correction by regarding the delay correction amounts HRV and HRA as valid values, if necessary. In any case, if a delay occurs in at least one of the image and the sound, the delay can be corrected so that synchronization between them can be realized.

In the embodiment described above, the configuration, the structure, the circuit, the shape, the number, the process contents, the process order, the process timings of the entire or a part of the input signal detecting portion NS, the output signal detecting portion SS, the image delay detecting portion 25, the sound delay detecting portion 26, the delay correction amount detecting portion 27 and the display device 1 can be modified in accordance with the spirit of the present invention, if necessary.

The present invention can be applied to the display device 1 as described above as well as other various image apparatuses such as a computer system, a television, a DVD reproduction apparatus, an AV apparatus and the like.

### INDUSTRIAL APPLICABILITY

The present invention can be used for a television, a DVD reproduction apparatus, an AV apparatus and a display device for them, and the like.

1. A synchronous control method between an image signal and an audio signal in an image apparatus having an image signal processing portion that performs signal processing on an input image signal, an image output portion that delivers the image after the signal processing, an audio signal processing portion that performs signal processing on an input audio signal and a sound output portion that delivers the sound after the signal processing, the method comprising the steps of:
storing signal states of the input image signal and the input audio signal in an input image storing portion and an input sound storing portion, respectively;
storing signal states of the image signal after the signal processing performed by the image signal processing portion and the audio signal after the signal processing performed by the audio signal processing portion in an output image storing portion and an output sound storing portion, respectively;
comparing the image signal stored in the input image storing portion with the image signal stored in the output image storing portion so as to determine delay time of the image signal;
comparing the audio signal stored in the input sound storing portion with the audio signal stored in the output sound storing portion so as to determine delay time of the audio signal;
determining a delay correction amount with respect to the image signal or the audio signal based on a difference between the determined delay time of the image signal and the determined delay time of the audio signal; and
correcting a delay of the image signal or the audio signal to be delivered, in accordance with the determined delay correction amount.

2. The synchronous control method between an image signal and an audio signal in an image apparatus according to claim 1, wherein
when the delay time of the image signal is determined,
a variation of the image signal stored in the input image storing portion and a variation of the image signal stored in the output image storing portion are determined, so that the delay time is determined from a position where correlation between the variations is highest, and
when the delay time of the audio signal is determined,
a variation of the audio signal stored in the input sound storing portion and a variation of the audio signal stored in the output sound storing portion are determined, so that the delay time is determined from a position where correlation between the variations is highest.

3. A synchronous control device between an image signal and an audio signal in an image apparatus having an image signal processing portion that performs signal processing on an input image signal, an image output portion that delivers the image after the signal processing, an audio signal processing portion that performs signal processing on an input audio signal and a sound output portion that delivers the sound after the signal processing, the device comprising:
an input image storing portion that stores a signal state of the input image signal;
an input sound storing portion that stores a signal state of the input audio signal;
an output image storing portion that stores a signal state of the image signal after the signal processing performed by the image signal processing portion;
an output sound storing portion that stores a signal state of the audio signal after the signal processing performed by the audio signal processing portion;
an image delay time detecting portion that compares the image signal stored in the input image storing portion with the image signal stored in the output image storing portion so as to determine delay time of the image signal;
a sound delay time detecting portion that compares the audio signal stored in the input sound storing portion with the audio signal stored in the output sound storing portion so as to determine delay time of the audio signal;
a delay correction amount detecting portion that determines a delay correction amount with respect to the image signal or the audio signal based on a difference between the determined delay time of the image signal and the determined delay time of the audio signal; and
a delay correcting portion that corrects a delay of the image signal or the audio signal to be delivered, in accordance with the determined delay correction amount.

4. The synchronous control device between an image signal and an audio signal in an image apparatus according to claim 3, wherein
the image delay time detecting portion determines a variation of the image signal stored in the input image storing portion and a variation of the image signal stored in the output image storing portion, so that the delay time of the image signal is determined from a position where correlation between the variations is highest, and
the sound delay time detecting portion determines a variation of the audio signal stored in the input sound storing portion and a variation of the audio signal stored in the output sound storing portion, so that the delay time of the audio signal is determined from a position where correlation between the variations is highest.

5. The synchronous control device between an image signal and an audio signal in an image apparatus according to claim 3, wherein
the input image storing portion and the output image storing portion sample and store a luminance signal at a constant period as the signal state of the image signal.

6. The synchronous control device between an image signal and an audio signal in an image apparatus according to claim 3, wherein
the input image storing portion and the output image storing portion store a frequency component of each frame as the signal state of the image signal.

7. The synchronous control device between an image signal and an audio signal in an image apparatus according to claim 3, wherein
the input sound storing portion and the output sound storing portion store a frequency component every predetermined time period as the signal state of the audio signal.

8. The synchronous control device between an image signal and an audio signal in an image apparatus according to claim 3, wherein
the input image storing portion and the output image storing portion sample and store a variation of a luminance signal at a constant period as the signal state of the image signal.

9. The synchronous control device between an image signal and an audio signal in an image apparatus according to claim 3, wherein
the input sound storing portion and the output sound storing portion sample and store a variation of the audio signal at a constant period as the signal state of the audio signal.

10. An AV apparatus comprising:
an image signal processing portion that performs signal processing on an input image signal;
an audio signal processing portion that performs signal processing on an input audio signal;
an input image storing portion that stores a signal state of the input image signal;
an input sound storing portion that stores a signal state of the input audio signal;
an output image storing portion that stores a signal state of the image signal after the signal processing performed by the image signal processing portion;
an output sound storing portion that stores a signal state of the audio signal after the signal processing performed by the audio signal processing portion;
an image delay time detecting portion that compares the image signal stored in the input image storing portion with the image signal stored in the output image storing portion so as to determine delay time of the image signal;
a sound delay time detecting portion that compares the audio signal stored in the input sound storing portion with the audio signal stored in the output sound storing portion so as to determine delay time of the audio signal;
a delay correction amount detecting portion that determines a delay correction amount with respect to the image signal or the audio signal based on a difference between the determined delay time of the image signal and the determined delay time of the audio signal;
a delay correcting portion that corrects a delay of the image signal or the audio signal to be delivered, in accordance with the determined delay correction amount;
an image output portion that delivers the image after the signal processing; and
a sound output portion that delivers the sound after the signal processing.

11. A synchronous control device between an image signal and an audio signal comprising:
an input image storing portion that stores a signal state of the input image signal;
an input sound storing portion that stores a signal state of the input audio signal;
an output image storing portion that stores a signal state of the image signal after the signal processing;
an output sound storing portion that stores a signal state of the audio signal after the signal processing;
an image delay time detecting portion that compares a variation of the image signal stored in the input image storing portion with a variation of the image signal stored in the output image storing portion, so as to determine delay time of the image signal;
a sound delay time detecting portion that compares a variation of the audio signal stored in the input sound storing portion with a variation of the audio signal stored in the output sound storing portion, so as to determine delay time of the audio signal;
a delay correction amount detecting portion that determines a delay correction amount with respect to the image signal or the audio signal based on a difference between the determined delay time of the image signal and the determined delay time of the audio signal; and
a delay correcting portion that corrects a delay of the image signal or the audio signal to be delivered, based on the determined delay correction amount.
